(19) United States
(12) Patent Application Publication
(10) Pub. No.: US 2015/0286936 A1
(43) Pub. Date: Oct. 8, 2015

(54) TRANSPORTATION ANALYSIS SYSTEM

(71) Applicant: Hitachi, Ltd., Tokyo (JP)

(72) Inventors: Shuhei Furuya, Tokyo (JP); Rieko Otsuka, Tokyo (JP)

(21) Appl. No.: 14/436,096

(22) PCT Filed: Oct. 17, 2012
(86) PCT No.: PCT/JP2012/076750

§ 371 Date: Apr. 16, 2015

(51) Int. Cl. G06N 5/04; G06Q 50/30

(52) U.S. Cl. CPC G06N 5/04; G06Q 50/30

(57) ABSTRACT

A special device must be installed in order to compile actual timetables of a public transportation facility, and the present invention relates to a method and system for compiling actual service across a plurality of transportation facilities in a wide range by estimating arrival times and departure times for cars and and/or railcars from usage status information of a user such as boarding location, boarding time, alighting location, and alighting time collected by a transportation system IC transit card, etc. when a public transportation facility is used, and generating a timetable for indicating actual service.

### TECHNICAL FIELD

The present invention relates to a technique and a system by which the arrival times and departure times of trains, cars and other vehicles are estimated from status information on users such as boarding locations, boarding times, alighting locations and alighting times collected by transportation system IC transit cards or the like when public transportation facilities are used, and a timetable indicating actual services is generated. The timetable indicating actual services will be hereinafter referred to as the departure/arrival timetable.

### BACKGROUND ART

Attempts to optimize operation management are made by transportation service operators with a view to improving the convenience and the operating efficiency of public transportation facilities. Generally, operators of public transportation facilities periodically revise their train or bus service timetables to improve the convenience of users and the efficiency of operation, and one of the important indicators used in such rescheduling is the crowdedness rate (load factor). In order to precisely figure out the train-by-train or car-by-car crowdedness rate, it is necessary to accurately grasp where each train or car was at what time and how many passengers the train or car was carrying, but it is difficult as a matter of practice to operate trains and passes exactly as scheduled; influences of an accident or traffic jam invites many minor delays, and often the operation runs into a situation of being obliged to deviate from the schedule. Therefore, the use of actual record-based timetables based on collected data of actual arrival times and departure times in estimating the crowdedness rate, managing operation and making a fluid prediction is considered to allow more accurate analysis instead of using planned operation timetables. However, mechanically collecting actual record-based timetables would require installation of special devices on cars and along railroads and motorways, and this would cost tremendous sums of money and periods of time.

On the other hand, Patent Literature 1 discloses a system that uses the boarding location, boarding time, alighting location and alighting time stated on the passenger ticket and the planned train timetable to identify the route taken for the travel.

### CITATION LIST

### Patent Literature

Patent Literature 1: Japanese Unexamined Patent Application Publication No. 2004-126775

### SUMMARY OF INVENTION

### Technical Problem

Incidentally, whereas the technique stated in Patent Literature 1 cited above concerns a method by which the route travelled, namely the train used, can be identified, it uses planned train timetables but does not take the actual state of operation into consideration.

In order to collect actual operation records, there is the problem of requiring special devices on cars, rail tracks and roads, which cost large amounts of money. Further, in order to collect operation records comprehensively from different transportation facilities including buses and trains, devices and systems matching individual transportation facilities should be introduced.

The object of the present invention, attempted in view of these problems, is to collect information on boarding positions, boarding times, alighting positions and alighting times from data in contactless type IC cards, which can be utilized in a broad range and applicable to a plurality of transportation facilities including buses and trains, and to estimate departure/arrival timetables in a broad range without requiring any special device.

### Solution to Problem

As means to solve the problem stated above, the present invention uses a transportation analysis system using a database including a transit log in which a user ID, a boarding day and time, an alighting day and time, a boarding position and an alighting position are associated with one another and a line master in which a line ID and station-to-stop information are associated with each other, the system including a single line estimating unit in which the transit log and the line master are extracted from the database, the presence or absence of a line ID including the boarding position and the alighting position associated with the transit log is confirmed on the basis of the line master and, if the presence is confirmed, single line estimating information associating the confirmed line ID and the transit log with each other is generated and stored into the database; and a departure/arrival timetable estimating unit that extracts the line master and the single line estimating information from the database, calculates, on the basis of the line master, the distribution of the number of alighting persons in the alighting position contained in the single line estimating information, calculates an arrival day and time and a departure day and time on the basis of the calculated distribution of the number of alighting persons, generates a departure/arrival timetable ID associated with each of the alighting position, the calculated arrival day and time and departure day and time and the line ID, and stores the ID into the database.

### ADVANTAGEOUS EFFECTS OF INVENTION

According to the present invention, it is possible to estimate departure/arrival timetables in a broad range applicable to all transportation facilities accessible with contactless type IC cards without requiring any special device. Further according to the present invention, it is possible to estimate departure/arrival timetables even for different transportation facilities including buses and trains in a similar way.

### BRIEF DESCRIPTION OF DRAWINGS

FIG. 1 is a configurative diagram of an example of the whole system doe implementing the present invention.

FIG. 2 is a diagram illustrating an example of structure of a record for storing information on the history of use of a contactless type IC card.

FIG. 3 is a diagram illustrating an example of structure of a record for storing transit log data generated from the history of use or the like of a contactless type IC card.

FIG. 4 is a diagram illustrating an example of structure of a record for storing information on the line names, line types and stop positions of individual transportation facilities.

FIG. 5 is a record for storing data on single line users extracted from a transit log by a single line user estimation program.

FIG. 6 is a diagram illustrating an example of structure of data of departure/arrival timetable storing operation record.

FIG. 7 is a diagram illustrating an example of processing procedure to generate a transit log from the history of use of a contactless type IC card.

FIG. 8 is a diagram illustrating an example of processing procedure to estimate single line users from the transit log and generating single line user estimation data.

FIG. 9 is a conceptual diagram showing the distribution of number of persons alighting at a station or bus stop on a given line among different time brackets.

FIG. 10 is a diagram illustrating an example of processing procedure to generate a departure/arrival timetable for estimating an arrival time from a line master and the single line user estimation data.

FIG. 11 is a diagram illustrating an example of processing procedure to generate a departure/arrival timetable that estimates the departure time from the single line user estimation data and an estimated arrival time and in which arrival times and departure time are estimated.

FIG. 12 is a diagram illustrating an example of processing procedure from identification of the train boarded by a user and calculation of the number of users of each train until generation of number of users data.

FIG. 13 is a diagram illustrating an example of processing procedure to estimate crowdedness rates.

FIG. 14 is a diagram illustrating an example of processing procedure to predict crowdedness rates.

FIG. 15 is a diagram illustrating an exemplar display of timetable expressly showing crowdedness rates.

FIG. 16 is a diagram illustrating an exemplar display of timetable expressly showing crowdedness rates of different transportation facilities.

FIG. 17 is a diagram illustrating an exemplar display of a line map expressly showing crowdedness rates.

FIG. 18 is a diagram illustrating an exemplar display of a line map expressly showing deviations from the timetable.

FIG. 19 is a diagram illustrating an exemplar display of results of route search using predictable crowdedness rates.

FIG. 20 is a diagram illustrating an exemplar display of results of route search using predictable crowdedness rates.

FIG. 21 is a diagram illustrating an exemplar display of results of route search using predictable congested time brackets.

FIG. 22 is a diagram illustrating an exemplar display of results of route search using predictable congested time brackets.

FIG. 23 is a diagram illustrating an exemplar display of transfer evaluation.

FIG. 24 is a diagram illustrating an example of screen for showing results of estimating convenient transfers between different lines.

FIG. 25 is a diagram illustrating an example of visualization of simulation results.

FIG. 26 is a diagram illustrating an example of screen on which input information and parameters for simulation are set.

FIG. 27 is a diagram illustrating an example of processing procedure to figure out predictable route crowdedness rates on the basis of inputs.

### DESCRIPTION OF EMBODIMENTS

### First Embodiment

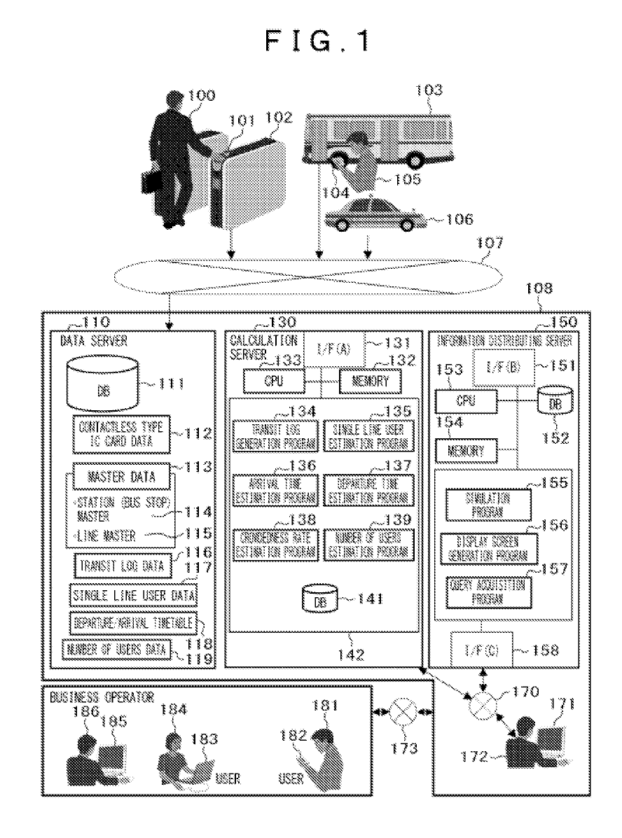

An example of system to estimate a departure/arrival timetable from contactless type IC card data will be described with reference to FIG. 1 through FIG. 27.

FIG. 1 is a configurative diagram of the whole estimating system of departure/arrival timetables using contactless type IC card data pertaining to this embodiment. In recent years, many users (100) of transportation facilities have come to pass, by utilizing contactless type IC cards or mobile terminals (101) having comparable functions, ticket gates for facilitating the use of transportation facilities or reading terminals (102) installed in vehicles. Data acquired by ticket gates and on-vehicle terminals is transmitted via a network (107) to a data server (110). This system (108) includes the data server (110), a calculation server (130) and an information distributing server (150), accumulates data on the use of contactless type IC cards or mobile terminals (104) having comparable functions, and processes analyses. Incidentally, description of the functions and configurations of the contactless type IC cards and the ticket gates is dispensed with.

When users (100) utilizing contactless type IC cards (101) pass a ticket gate (102), user IDs for identifying contactless type IC cards (101) and information including the days and times of passage are accumulated in the ticket gate (102), and needed parts are sent to the data server (110) at appropriate timing, such as at the same time as storage, at one-hour or one-day intervals. This system (108) is supposed to be able to communicate via a network (173) with a business operator (186) and/or users (181 and 184). To add, though this embodiment will be described as a system including a group of servers including the data server (110), the calculation server (130) and the information distributing server (150), everything may as well be executed by a single server, or it is also possible to cause a plurality of servers to execute the functions of the group of servers in parallel.

The data server (110) records in a data storage (111) in the server users' data read by IC card reader terminals, such as ticket gates. The data collected and stored includes the contactless type IC card data (112) and basic master data (113) regarding stations, bus stops and lines. Further, transit log data (116) resulting from primary processing of the contactless type IC card data, and single line user data (117) resulting partial extraction from transit log data and processing, together with a departure/arrival timetable (118) and number of users data (119) figured out by using these sets of data, are stored. The basic master data (113) related to stations and lines is updated and recorded as appropriate when there is any alteration regarding line structure or updating. These sets of contactless type IC card data (112) should desirably be stored with sufficient consideration for privacy by, for instance, encrypting or making anonymous to prevent identification of individual persons.

In the calculation server (130), processing to generate transit log data from data accumulated in the data server (110), processing to estimate single-line users traveling by only one train or car, processing to estimate arrival times, departure times and crowdedness rates of trains, or processing to estimate the number of users of a given train or car are carried out. The calculation server (130) is mainly configured of a network interface (131), a CPU (133), a memory (132) and a memory unit (142). The network interface (I/F (A)) is an interface for connection to a network. The memory unit (142) holds a group of programs including a transit log generation program (134), a single line user estimation program (135), an arrival time estimation program (136), departure time estimation program (137), a crowdedness rate estimation program (138) and a number of users estimation program (139) and a data storage (141) for storing results of calculation processing among others. As the memory unit, a hard disk drive, a CD-ROM drive or a flash memory is available, or various programs and/or various kinds of data may be divided and recorded in a plurality of recording devices.

When any of the groups of programs is to be executed, various functions are realized by reading the data to be analyzed out of the data server (110), temporarily storing them into the memory. (132), and causing the CPU (133) to read each of the programs (134, 135, 136, 137, 138 and 139) into the memory and executing it. The execution of the programs may be so configured as to be timed to, for instance, a request from a user or addition of new data to the data server (110) or automatically at a set point of time every day as batch processing. Or if the data to be analyzed is transmitted on a real-time basis, only newly added differential data for the program groups (134, 135, 136, 137, 138 and 139) may be processed as well.

The information distributing server (150) is provided with network interfaces (I/F (B)) (151) and (I/F (C)) (159), a CPU (153), a memory (154) and a recording device (152). The network interfaces are interfaces for connection to networks. The recording device, intended for recording of various programs and various kinds of data, may be a hard disk drive, a CD-ROM drive or a flash memory. Or various programs and/or various kinds of data may be divided and recorded in a plurality of recording devices. The CPU (153) executes various functions by reading various programs (155, 156 and 157) recorded in the recording device (152) into the memory (154) and executing them. A system operator (172), by using an information terminal (171), can check the situations of various programs and calculation results in the information distributing server and the calculation server via a network (170). Also, when estimating the congesting rate or estimating the length of waiting time, it can set parameters in the simulation among other functions.

Information including the simulation results, departure/arrival timetable and results of evaluation of passengers' convenience generated by this system (108) can be distributed to users (181 and 184) and a business operator (186) via the network (173), and can be acquired at information terminals (182, 183 and 185), such as mobile terminals.

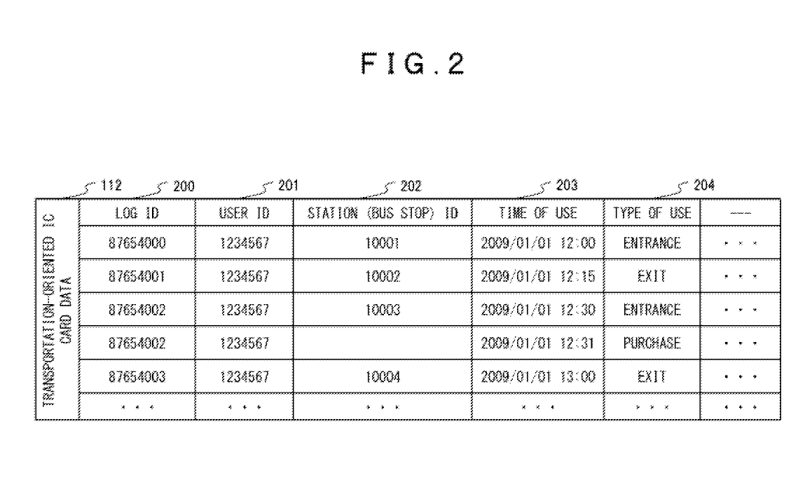

FIG. 2 is a diagram showing an example of data structure of typical data to be stored in the data server (110). First, the contactless type IC card data (112) includes such information as a log ID (200), an object user ID (201), a station or bus stop ID (202) tied to information on what data reading terminal has been passed, the time of use (203) of having passed that reading terminals and a type of use (204). The type of use here is information that indicates, for instance, “entrance” or “exit” if what is used is a ticket gate or an entrance/exit gate or, “purchase” if it is a terminal for selling goods. Transmission of the contactless type IC card data may be received at each time of new data generation or collectively in a late night time zone, when the use decreases.

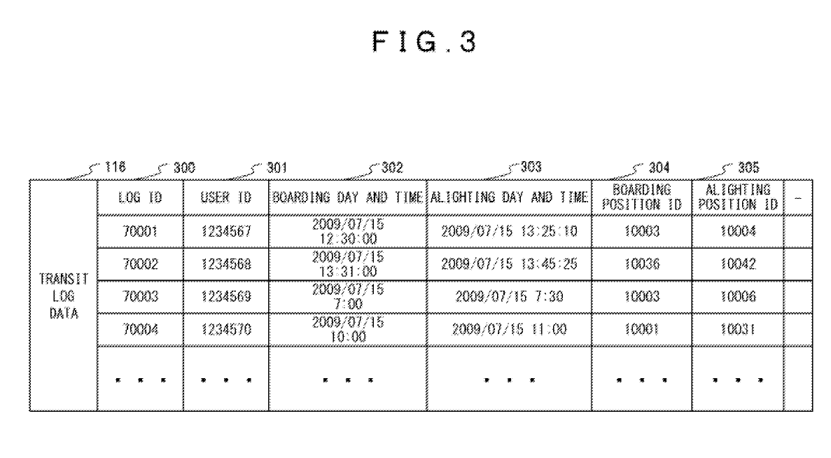

FIG. 3 is a diagram showing another example of data structure of typical data to be stored in the data server (110). The transit log data (116) includes a log ID (300) for identifying a log, an object user ID (301), a boarding day and time (302) indicating the time of boarding, an alighting day and time (303) indicating the time of ending the use of the transportation facility at the arrival point, a boarding position station ID (304) and an alighting position ID (305). This transit log data (116) is data after primary processing, generated from the contactless type IC card data (112).

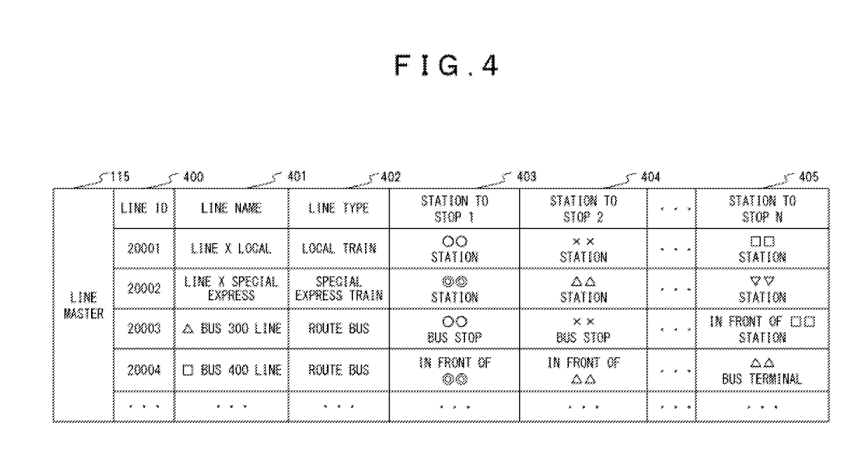

FIG. 4 is a diagram showing still another example of data structure of typical data to be stored in the data server (110). A line master (115) contains information including a line ID (400) for identifying a line, its line name (401), a line type (402) for identifying local trains, special express trains and route buses, and stations to stop (403 to 405) for stopping on each line.

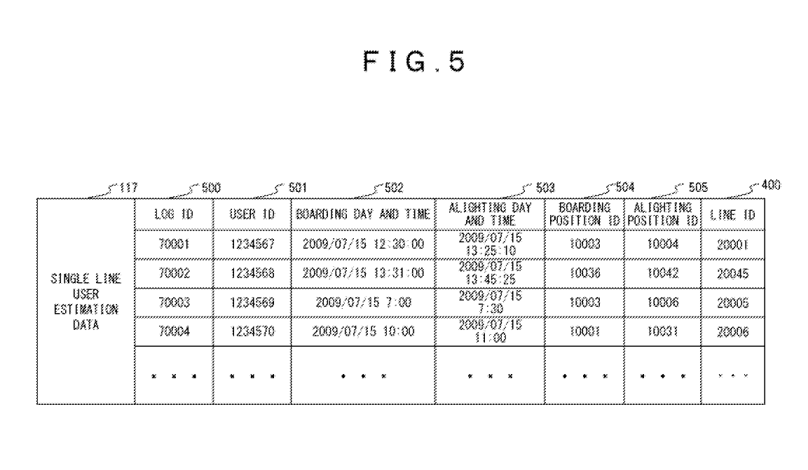

FIG. 5 is a diagram showing yet another example of data structure of typical data to be stored in the data server (110). The single line user estimation data (117) contains a log ID (500) for identifying a log, an object user ID (501), a boarding day and time (502), an alighting day and time (503), a boarding position ID (504), and an alighting position ID (505), and the line ID (400) of the line used. This single line user estimation data (117) is processed data generated by using the transit log data (116) and the line master (115).

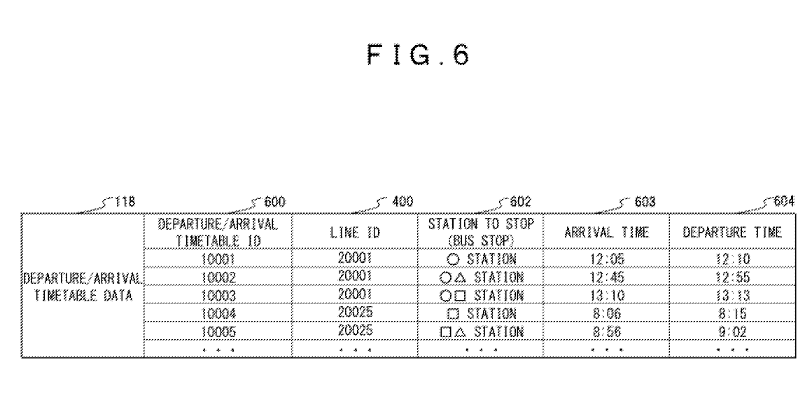

FIG. 6 is a diagram showing still another example of data structure of typical data to be stored in the data server (110). The departure/arrival timetable data (118) contains information on a departure/arrival timetable ID (600) for identifying a departure/arrival timetable, its line ID (400), a station to stop or bus stop (602), an arrival time (603) and a departure time (604), both estimated according to the present invention.

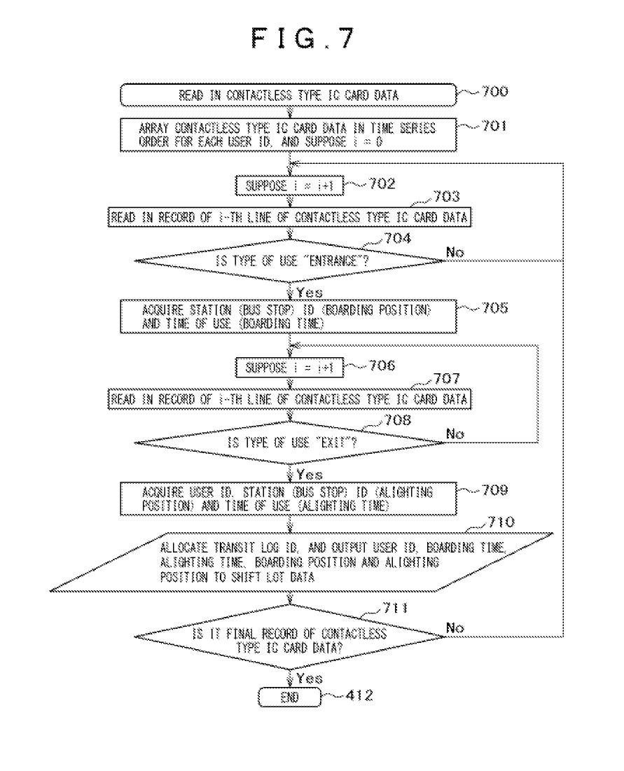

FIG. 7 is a diagram charting the procedure of processing a transit log generation program (134) for generating the transit log data (116) from the contactless type IC card data (112). The description here will suppose that processing of storage into the data server (110) is done by batch processing every day at a set point of time. First, the contactless type IC card data is read in (step 700). The read-in data is arrayed in the order of time series for each user ID, and i=0 is supposed (step 701). With i=i+1 being supposed (step 702), the i-th line of data arrayed in the order of time series is read in (step 703). If the type of use on the read-in line is entrance, the station (bus stop) ID, which serves as information on the boarding position, and the time of use, which serves as information on the boarding time, are acquired (step 705). With i=i+1 being supposed (step 706), the i-th line of the contactless type IC card data is read in (step 707). If the type of use on the record is exit (step 708), the user ID, the station (bus stop) ID, which serves as information on the alighting position, and the time of use, which serves as information on the alighting time, are acquired (step 709). Based on the information acquired at step 705 and the information acquired at step 709, a transit log ID, which is a serial number, is allocated, and the user ID, the boarding time, the alighting time, the boarding position and the alighting position are outputted to the transit log data (step 710). If the type of use on the record is not exit at step 708, the next record is read in. If the i-th line is not the final line of the contactless type IC card data, the processing returns to step 702 or, if it is the final line, the processing is ended (step 712).

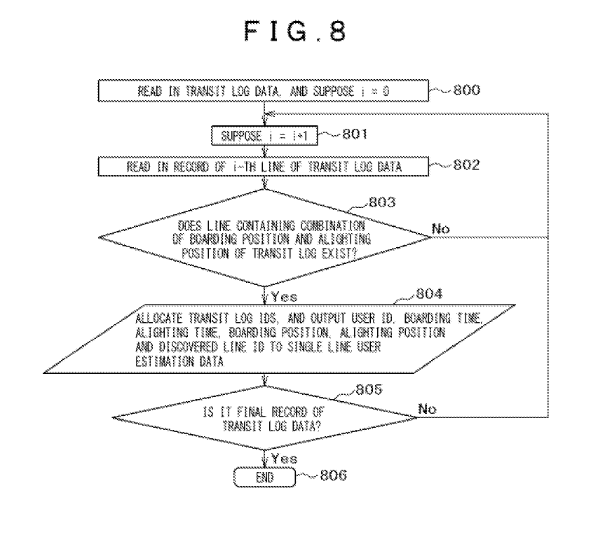

FIG. 8 is a diagram charting the procedure of processing a single line user estimation program (135) for estimating from the transit log data (116) a single line user having made no transfer from the time of boarding until that of alighting thereby to generate the single line user estimation data (117). The single line user here means a user who is very likely to have travelled by a single train or a single bus from the boarding position to the alighting position.

First, the transit log data is read in, and i=0 is supposed (step 800). With i=i+1 being supposed (step 801), the record on the i-th line of the transit log data is read in (step 802). Whether or not there is any line involving a possible combination of the boarding position and the alighting position exists is checked by using the line master (115) (step 803). If there is such a combination of the boarding position and the alighting position, a log ID, which is a serial number of the single line user estimation data, is allocated, and the user ID, the boarding time, the alighting time, the boarding position, the alighting position and the discovered line ID are outputted to the single line user estimation data (step 804). If the result of processing of step 804 indicates the absence of any such line, the processing returns to step 801. If the i-th line is the final record of the transit log, the processing is ended or, if the i-th line is not the final record, the processing returns to step 801.

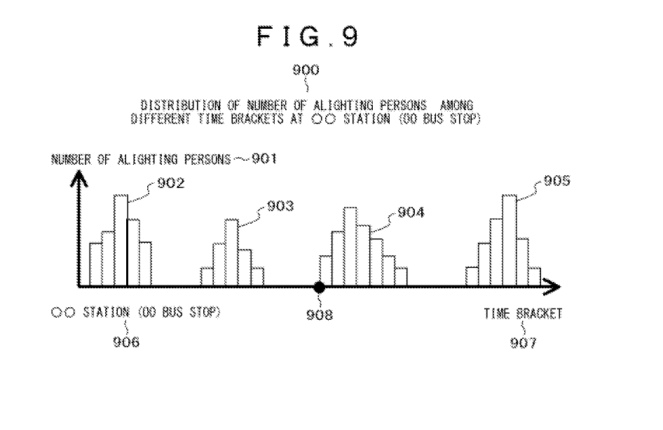

FIG. 9 is a conceptual diagram showing the distribution of number of persons alighting at a station or bus stop on a given line among different time brackets in the single line user estimation data (117). It is supposed that, with the horizontal axis representing the time (907) and the vertical axis, the number of alighting persons (901), a histogram on the number of persons is drawn here. Where such a histogram of the number of alighting persons is drawn with note taken of a given place, there usually occurs division into two kinds of parts, in one of which alighting groups consecutively appear (902, 903, 904 and 905) and in the other no alighting person appears at all. This is due to the circumstance that, when means of public transportation arrives at a station or a bus stop, most of its users go straight toward the ticket gate of the station or the alighting position of the bus and passes the ticket check by holding out a card over an IC card reader or gets off the bus, with the result that the use records of users concentrate in some time brackets. After all the users have alighted, there will be virtually no person alighting at the station or bus stop until the next train or bus arrives. To take note of consecutive histogram parts (904), it is presumable that a train or bus has arrived near the first time of histogram appearance (908). Although it is usual for the first time of consecutive histogram appearances to be supposed as the arrival time of a train, it is also possible to consider increases or decreases with these appearances as reference points. Also, a histogram having two peaks on account of short intervals between consecutive trains or some other reason can be regarded as showing a mixed distribution, and multiple peaks may be detected by shape recognition. For instance, there is a method by which, for instance, a point where the inclination of the histogram changes from upward to downward, and points where the change is greater than a certain threshold are deemed to be peaks.

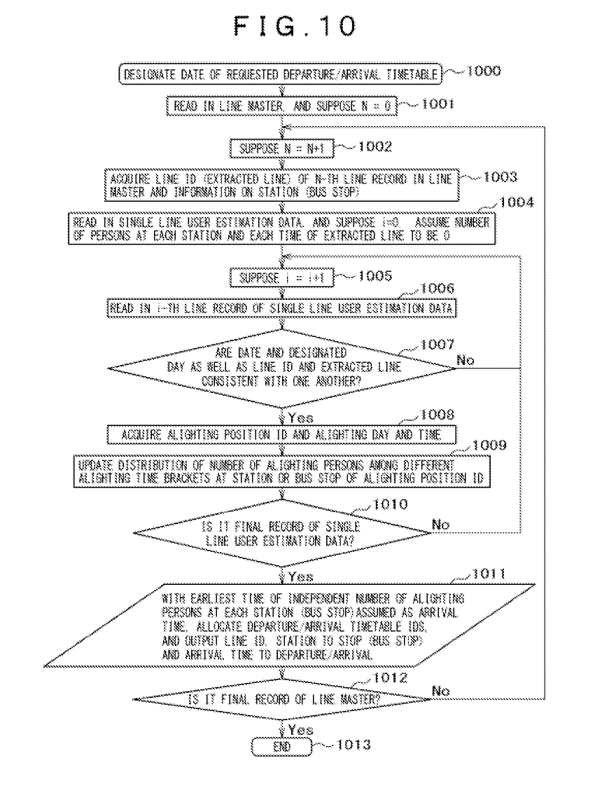

FIG. 10 is a diagram charting the procedure of processing of an arrival time estimation program (136) for estimating the departure/arrival timetable (118) from the single line user estimation data (117). First, the day for which the departure/arrival timetable (118) is required is designated (step 1000). The line master (115) is read in, and N=0 is supposed (step 1001). N=N+1 is supposed (step 1002). In the following procedure of the N-th line record in the line master, a line ID and information on stations to stop (bus stops) of the line, which serve as information on the extracted line, are acquired (step 1003). Then, the arrival time at each station to stop (bus stop) on an extracted line is estimated. First, the single line user estimation data is read in, and i=0 is supposed (step 1004). i=i+1 is supposed (step 1005). The i-th line record of the single line user estimation data is read in (step 1006). It is determined whether or not consistency exists between the date of the data read in at step 1006 and the designated day as well as between the line ID and the extracted line (step 1007). If consistency exists, an alighting position ID (502) and alighting day and time (503) are acquired (step 1008). The distribution is updated by increasing the number of alighting persons at the station or bus stop of the alighting position ID with respect to the alighting time by one (step 1009). If the i-th line record at step 1006 is not the final record of the single line user estimation data, the processing returns to step 1005 (step 1010). Or, if no consistency is found between the date and the designated day and between the line ID and the extracted line at step 1007, the processing also returns to step 1005. If the final record of the single line user estimation data is found at step 1010, the earliest time of the consecutive histogram of the distribution of the number of alighting persons at each station (bus stop) is supposed to be the arrival time, and the departure/arrival timetable ID (600) is allocated, and the line ID (400), the station to stop (bus stop) (602) and the arrival time (603) are outputted to the departure/arrival timetable data (118) (step 1011). If the N-th line is the final record of the line master (115), the processing is ended or, if it is not the final record, the processing returns to step 1002.

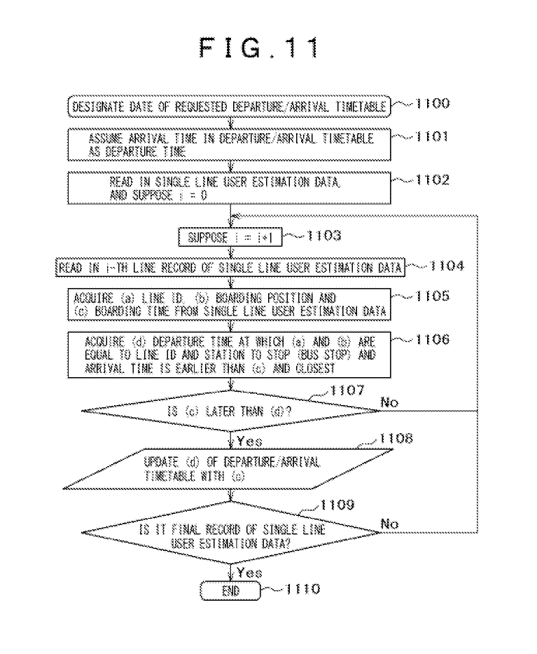

FIG. 11 is a diagram charting the procedure of processing of the departure time estimation program (137) for estimating the departure time from the single line user estimation data (117) and the departure/arrival timetable (118) estimating the arrival time and outputting it to the departure/arrival timetable (118). First, the day of requiring the departure/arrival timetable (118) is designated (step 1100). The arrival time in the departure/arrival timetable is supposed to be the departure time (step 1101). The single line user estimation data is read in, and i=0 is supposed (step 1102). i=i+1 is supposed (step 1103). The i-th line record of the single line user estimation data is read in (step 1104). From the single line user estimation data, (a) the line ID (400), (b) the boarding position ID (504) and (c) the boarding time (502) are acquired (step 1105). Data of equality between (a) and (b) respectively to the line ID and the station to stop (bus stop) in the departure/arrival timetable is searched for to specify the line ID used by a user. The departure time of the boarding position is estimated from the time of boarding by that user. If the boarding time is later than the departure time kept in the departure/arrival timetable, it means that the transportation facility had not departed at least until the boarding time, and accordingly the departure time of the departure/arrival timetable (118) is replaced with (c) (steps 1106, 1107 and 1108). If the i-th line is the final record of the single line user estimation data, the processing is ended or, if it is not the final record, the processing returns to step 1103. Or if (c) is not later than (d) at step 1107, the processing also returns to 1103.

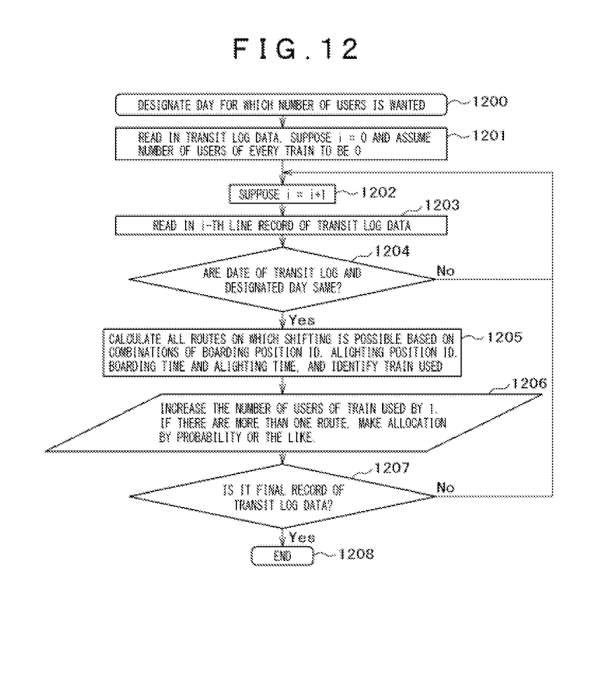

FIG. 12 is a diagram charting the procedure of processing of a number of users estimation program (139) to identify the trains boarded by a user from the transit log data (116) and the departure/arrival timetable (118) and to calculate the number of users of each train until preparation of number of users data (119). First, the day of requiring the number of users is designated (step 1200). The transit log data (116) is read in, i=0 is supposed, and the number of users of every train is supposed to be 0 (step 1201). i=i+1 is supposed (step 1202). The i-th line record of the transit log data is read in (step 1203).

It is judged whether or not the date of the transit log is consistent with the designated day (step 1204). If it is, every route on which travel is possible is calculated from the combination of a boarding position ID, an alighting position ID, a boarding time and an alighting time on the basis of the departure/arrival timetable, and the boarded train is identified (step 1205). The number of users of the boarded train is increased by 1. If there are more than one route, allocation according to the probability or a like application may be performed (step 1206). If the i-th line record is the final record of the transit log data, the processing is ended or, if it is not the final record, the processing returns to step 1202.

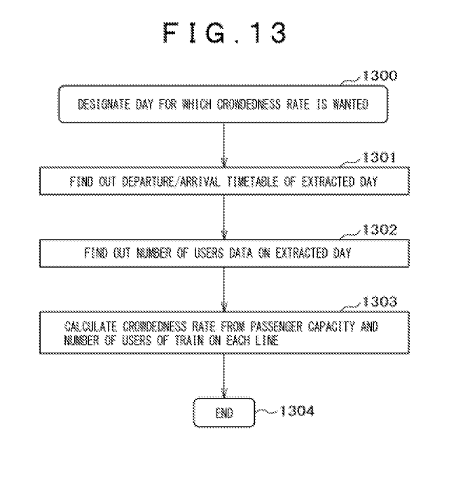

FIG. 13 is a diagram charting the procedure of processing of a crowdedness rate estimation program (138) for estimating the crowdedness rate by using the number of users data (119). First, the day of requiring the crowdedness rate is designated (step 1300). Next, the departure/arrival timetable (118) of the designated day is generated by using the arrival time estimation program (136) and the departure time estimation program (137) (step 1301). The number of users data (119) is generated from the generated departure/arrival timetable by using the number of users estimation program (139) (step 1302).

The ratio of the number of users to the passenger capacity of the train (bus) on each line is supposed to be the crowdedness rate of each train (bus) (step 1303).

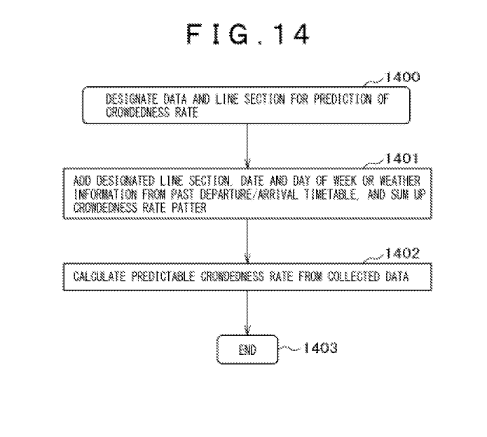

FIG. 14 is a diagram charting the procedure of calculating a predictable crowdedness rate from the result of calculating past crowdedness rates. First, the day of requiring the crowdedness rate is designated (step 1400). The pattern of the crowdedness rate is totalized by adding information on the line section, date, day of the week and weather from the past crowdedness rate data (step 1401). The prediction of the crowdedness rate is calculated from the totalized result (step 1402).

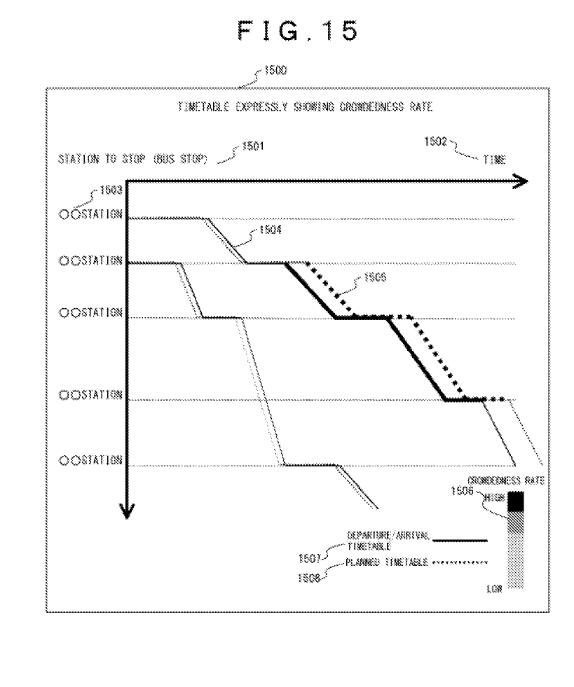

FIG. 15 is a diagram of a timetable expressly showing information on the resultant crowdedness rate, representing an example of display screen generated by the information distributing server (150) and distributed to system operators, business operators and the like. The configuration of a screen (1500) is such that stations to stop (bus stops) on the noted line or route are arrayed on the vertical axis (1503) in the order of stopping sequence and the horizontal axis (1502) represents the time, the departure/arrival state of the transportation facility being depicted in lines of colors (1506) according to the crowdedness rate. The description here supposes a configuration in which an actual departure/arrival timetable figured out by using the transit of users extracted by single line user estimation according to the present invention is represented by solid lines (1504 and 1507) and a planned timetable is represented by dotted lines (1505 and 1508), but the configuration is not limited to this embodiment. Regarding the displaying of the crowdedness rate estimation result, which is a feature of the present invention, in place of color differences, line thickness may as well be used or differentiation may be achieved with the line type. It is also possible to display the predictable crowdedness rate in text near the lines of the timetable. The use of such a screen would make possible visual recognition of what line section has a higher crowdedness rate, enabling various discoveries to be made regarding the place and time bracket where the density of users is high in managing operation or drafting an operation plan. Or the whole screen may conceivably be manipulated by using an input interface such as a mouse or a keyboard, for instance to be provided with functions to achieve zooming in or out with a wheel button or the like and to enlarge information on a specific station, bus stop or line by clicking of the mouse.

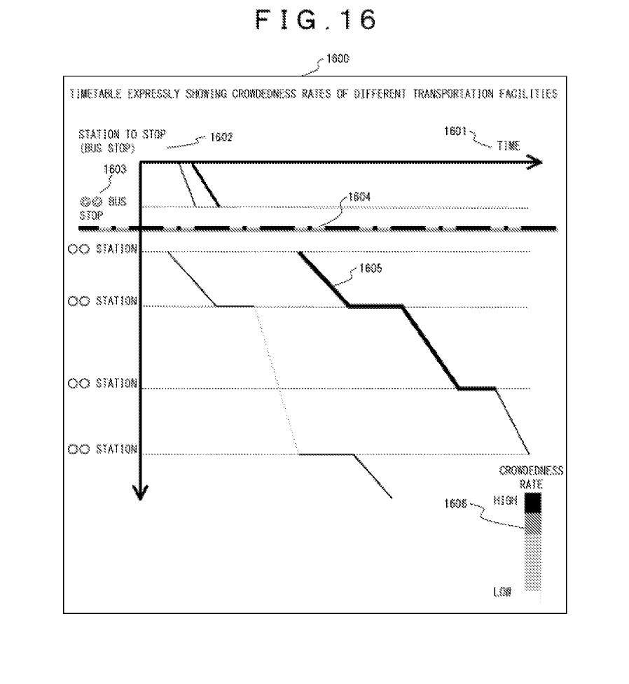

FIG. 16 is a timetable expressly showing information on the connection state among different transportation facilities and the resultant crowdedness rate, representing an example of display screen generated by the information distributing server (150) and distributed to system operators, business operators and the like. The configuration of a screen (1600) is such that stations to stop (bus stops) (1603) on the noted line or route are arrayed on the vertical axis (1602) in the order of stopping sequence and the horizontal axis (1601) represents the time, the departure/arrival state of the transportation facility being depicted in lines (1605) using colors (1606) according to the crowdedness rate. Regarding the displaying of the crowdedness rate estimation result, which is a feature of the present invention, in place of colors line thicknesses may be used for its representation. It is also possible to display numerals of the figured-out crowdedness rate in text near the lines of the timetable. Since information on the departure/arrival timetable (118) can be collected in the whole range of use of contactless type IC card data, it is possible to calculate the crowdedness rate for a plurality of transportation facilities and prepare a timetable. For instance, a bus line and a railway line are arrayed along with each other, and transfer parts between the different transportation facilities can be expressly represented with a partitioning line (1604).

Use of such a screen would enable the length of waiting time when transferring from bus to railway or from railway to bus to be grasped by looking at discrepancies in timetable between the different transportation facilities, making it possible to take into account the state of connection between different transportation facilities in managing operation or drafting an operation plan.

The whole screen may conceivably be manipulated by using an input interface such as a mouse or a keyboard, for instance to be provided with functions to achieve zooming in or out with a wheel button or the like and to enlarge information on a specific station, bus stop or line by clicking the mouse. Furthermore, use of a touch panel may also be possible.

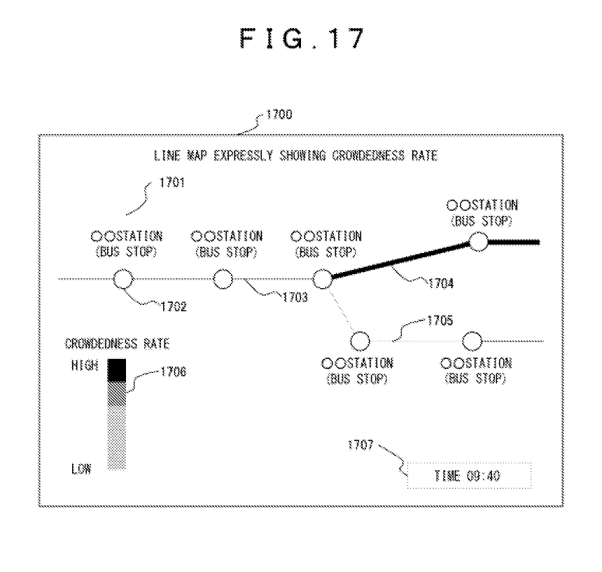

FIG. 17 shows an example of display screen generated by the information distributing server (150) for distribution to system operators and business operators, a line drawing expressly depicting information on the result of crowdedness rate estimation, which is a feature of the present invention. A screen (1700) is configured of a point (1702) representing a station to stop or bus stop, a line (1703) representing a railway or bus line, lines (1704 and 1705) expressing the crowdedness state of trains or buses by using colors (1706) matching the crowdedness rate, and time (1707).

For the displaying of the crowdedness rate, in place of color differences line thickness or line type may as well be used. The screen (1700) is intended to have a configuration for animated displaying of results of crowdedness rate estimation on each line figured out at 30-minute or one-hour intervals by extraction of single line use and a crowdedness rate estimating technique, which are features of the present invention.

Use of such a screen would conceivably make possible formulation of a more efficient operation timetable in operation management or at the time of planning operation because trends can be grasped by taking a look at the line or line section where crowdedness is arising while viewing positional relations on the line or displaying variations in crowdedness rate figured out from past data. Furthermore, since the use of a large quantity of historical data on IC passenger tickets would allow prediction of the crowdedness rate in the future, displaying of the results of such prediction would also give users of railways and/or buses effective information to refer to in judging what transportation facility could be more useful.

The whole screen may conceivably be manipulated by using an input interface such as a mouse or a keyboard, for instance to be provided with functions to achieve zooming in or out with a wheel button or the like, to designate a position on the line by mouse dragging and to enlarge information on a specific station, bus stop or line by clicking the mouse.

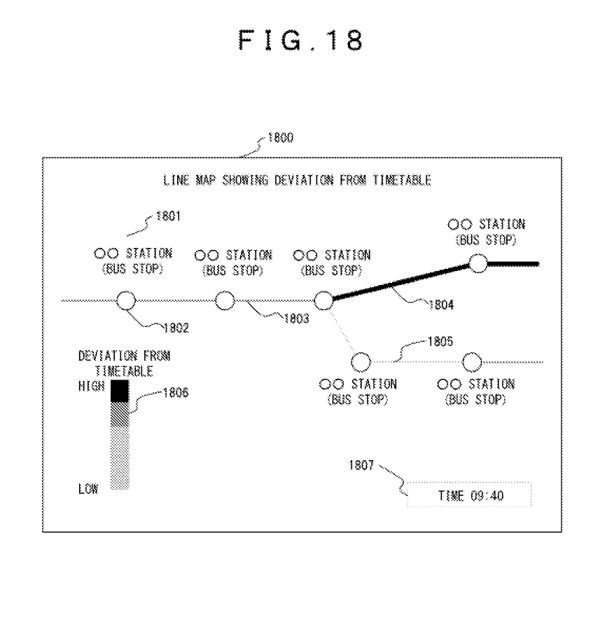

FIG. 18, showing an example of display screen generated by the information distributing server (150) for distribution to system operators and business operators, is a visualized diagram of deviation from the timetable prepared by calculating differences from the operation plan by using actual departure/arrival timetable data estimated according to the present invention and planned timetable data and depicting the result on a line drawing. A screen (1800) is configured of a point (1802) representing a station to stop or bus stop, a line (1803) representing a railway or bus line, lines (1804 and 1805) expressing the deviation from the timetable by using colors (1806) matching the crowdedness rate, and time (1807). The magnitude of deviation from the timetable can be represented by line thickness or line type in place of color differences.

Use of such a screen would conceivably make it possible to take a look at the line or line section where operation is disturbed while viewing positional relations on the line or display variations in deviation from the timetable figured out from past data to grasp long-term trends.

The whole screen may conceivably be manipulated by using an input interface such as a mouse or a keyboard, for instance to be provided with functions to achieve zooming in or out with a wheel button or the like, to designate a position on the line by mouse dragging and to enlarge information on a specific station, bus stop or line by clicking the mouse.

Information for generating the screens of FIG. 15 to FIG. 18 is accumulated in the memory unit (141) of the calculation server (130); persons in charge at a system operator (172) or each transportation business operator is supposed to acquire needed information in accordance with designated conditions by accessing a prescribed Web page and choosing an item according to a pull-down menu or the like. The information distributing server (150) edits the acquired information and distributes the information.

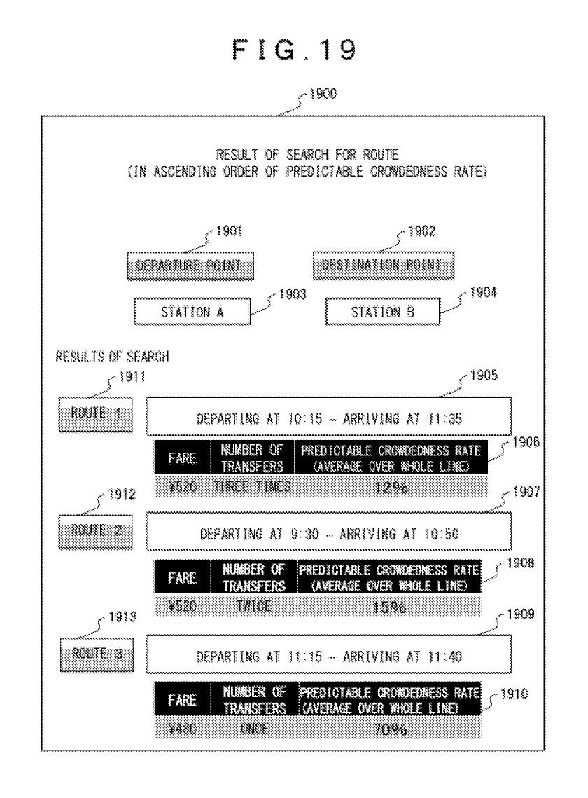

FIG. 19 is a diagram showing an example of route search result screen (1900), with a predictable crowdedness rate taken into consideration, generated and distributed by the information distributing server (150).

The predictable crowdedness rate is a statistically derived predictable value of a likely future change from the crowdedness rate of multiple past days figured out by using extraction of single line use and a crowdedness rate estimating technique, which are features of the present invention, on the basis of a large quantity of historical data on IC passenger tickets.

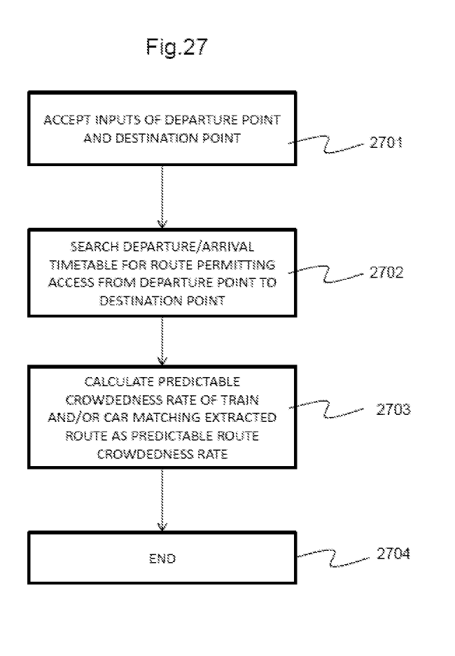

FIG. 27 charts actions in this case. First, inputs of the departure point and the destination point are accepted (2701). Next, on the basis of the inputted departure and destination place names, a route permitting access from the departure point to the destination point is searched for according to the actual departure/arrival timetable data (2702). Further, the predictable crowdedness rate of each train and/or car matching the extracted route is chosen as the predictable route crowdedness rate for the route (2703). Then, if the actual departure/arrival timetable data is estimated and stored for a long period, it is possible to derive highly accurate prediction values from averages and variance values in the long-term timetable data.

The screen (1900) is configured of a departure point (1901), a departure point entry column (1903), a destination point (1902), a destination point entry column (1904), a plurality of ID numbers (1911, 1912 and 1913) of the routes for displaying search results, and typical information items (1905, 1906, 1907, 1908, 1909 and 1910) on the routes including the departure time, arrival time, fare, number of transfers and predictable crowdedness rate. The information on the routes is not limited to this form of embodiment, but it is also conceivable to display in a button form only the route ID numbers (1911, 1912 and 1913) for instance, so that pressing a button would result in a jump to such detailed information items as the transfer point, the fare on each line and the predictable crowdedness rate on each line.

Although results of conventional route search usually presented information on only the fare, the time taken and the number of transfers, the use of such a screen enable the user, when in transit, to judge what route would provide the most pleasant travel, including the aspect of the predictable crowdedness rate.

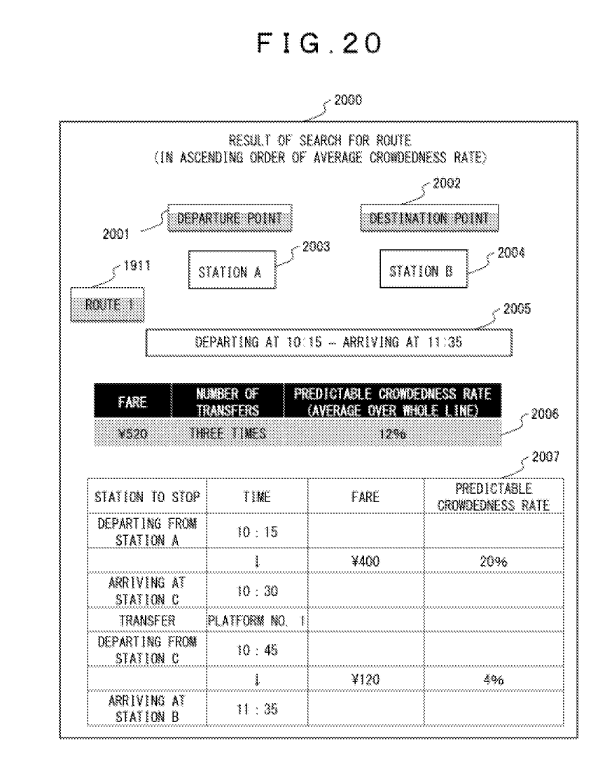

FIG. 20 is a diagram showing an example of display screen when route 1 (1911) shown in FIG. 19 has been chosen. A screen (2000) is configured of a departure point (2001), a departure point name (2003), a destination point (2002), a destination point name (2004), a route number (1911), a station to stop or time (2005), an integrated indication (2006) and detailed indications (2007) regarding the fare and predictable crowdedness on each line. The configuration may as well permit alteration on this screen of the departure point (2001), the destination point (2003) the route number (1911) desired to look at.

As the use of such a screen enables the user to compare detailed information on diverse routes, eventually the user can choose the most pleasant route according to his or her values. Although the screen (1900) is shown in a display form in which the search results are arrayed in the ascending order of the average crowdedness rate, the display may follow a standard easier to look at for the user, such as in the ascending order of the fare or the ascending order of the number of transfers.

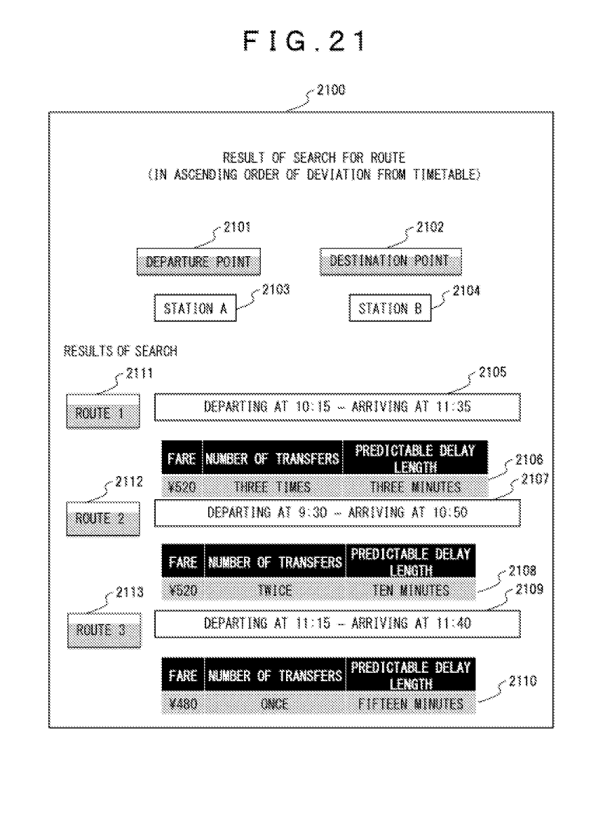

FIG. 21 is a diagram showing an example of route search screen (2100) for users, generated and distributed by the information distributing server (150) with deviations from the timetable taken into consideration. The screen (2100) is configured of a departure point (2101), an entry column (2103) for the departure point, a destination point (2102), an entry column (2104) for the destination point, ID numbers (2111, 2112 and 2113) for displaying a plurality of search results of the routes, and typical information items (2105, 2106, 2107, 2108, 2109 and 2110) on the routes including the departure time and arrival time, fare and number of transfers. The configuration may as well permit alteration on this screen of the departure point name (2103), the destination point name (2104) and the route numbers (2111, 2112 and 2113) desired to look at.

For instance, it is also conceivable to display in a button form only the route ID numbers (2111, 2112 and 2113), so that pressing a button would result in a jump to such detailed information items as the transfer point, the fare on each line and the predictable crowdedness rate on each line. Although the screen (2100) is shown in a display form in which the search results are arrayed in the ascending order of deviations from the timetable, the display may follow an order integrally combined with the ascending order of the fare or the ascending order of the number of transfers.

Although results of conventional route search usually presented information on only the fare, the time taken and the number of transfers, the use of such a screen enable the user, when in transit, to judge what route would best enable the travel to be made as scheduled unaffected by deviations from the timetable.

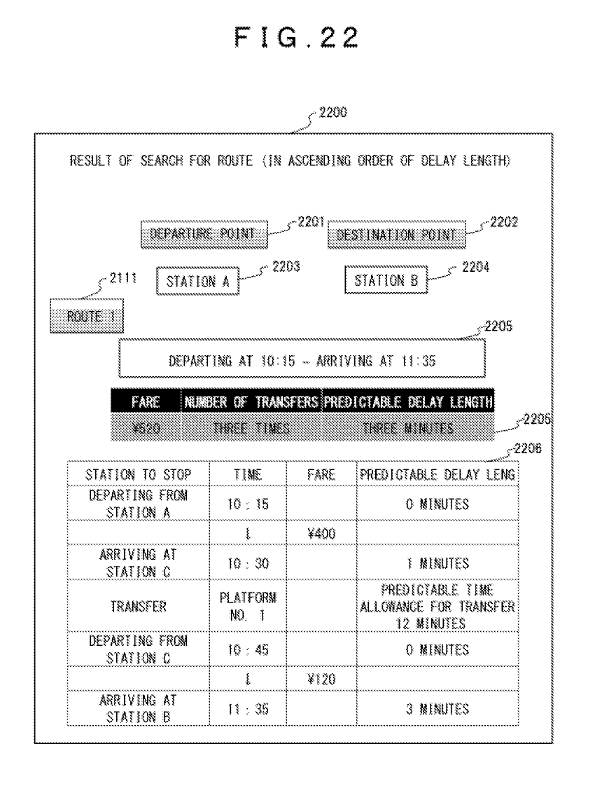

FIG. 22 is a diagram showing an example of display screen when route 1 (2111) shown in FIG. 21 has been chosen. A screen (2200) includes a departure point (2201), a departure point name (2203), a destination point (2202), a destination point name (2204), a route number (2111), a station to stop or time (2205), an integrated indication (2206) and detailed indications (2207) regarding the fare and predictable crowdedness on each line. Here, the configuration may as well permit alteration on this screen of the departure point (2201), the destination point (2203) and the route number (2111) desired to look at, and it is desirable for free choice to be possible. In the column of detailed indications (2207), the fare, predictable delay time and transfer time on each line are displayed among others.

Use of such a screen enables the user to take into account the delay time of a train or car in choosing the route to be taken. In such a case, when the train or bus is running as stated in the planned timetable, namely exactly as stated in the timetable, even if it is considered that there is no enough time to make a transfer, use of the actual departure/arrival timetable estimating technique according to the present invention would allow for the delay time, and therefore it may be determined that the transfer is possible. Since this allows indication of the route that would promise the earliest arrival at the destination, effective information for the user in a hurry can be provided.

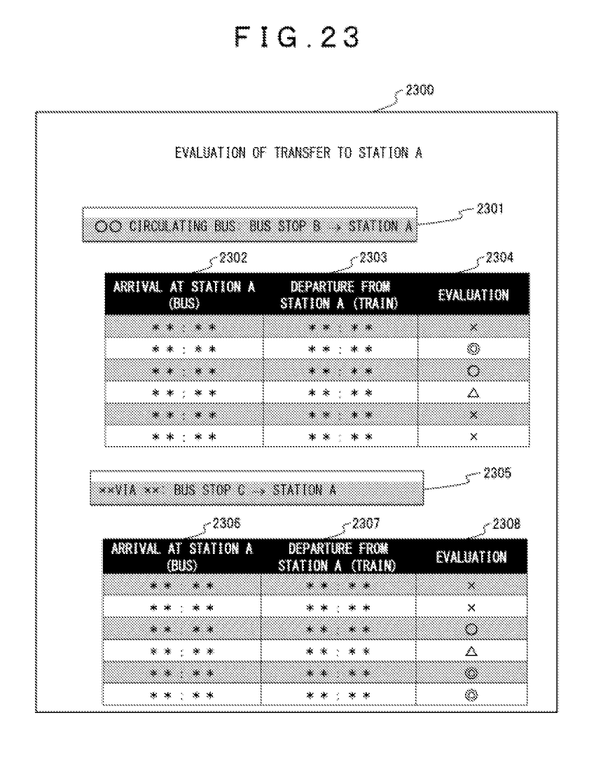

FIG. 23 is a diagram showing an example of screen (2300) for users generated and distributed by the information distributing server (150) regarding the result of evaluation of the ease of transfer from bus to railway station. The screen (2300) includes indications (2301 and 2305) from the departure point to the arrival point, bus arrival times (2302 and 2306) at the nearest bus stop to the station, train departure times (2303 and 2307) and transfer evaluations (2304 and 2308). The bus arrival times(2302 and 2306) and train departure times (2303 and 2307) are values obtained by using the actual departure/arrival timetable estimating technique according to the present invention and, when IC passenger ticket historical data, which is the original data, is available for use over a long period, averages reflecting day-to-day fluctuations are displayed.

Evaluation of a transfer can be figured out from transfer-permitting time length data calculated from a difference based on the actual departure/arrival timetable data and the number of user having actually made this transfer among other factors, and its expression may as well use numerals, signs, colors and the like. Evaluation can be made of not just a transfer from bus to train but also of ones from train to bus, between different bus lines and between different railway lines.

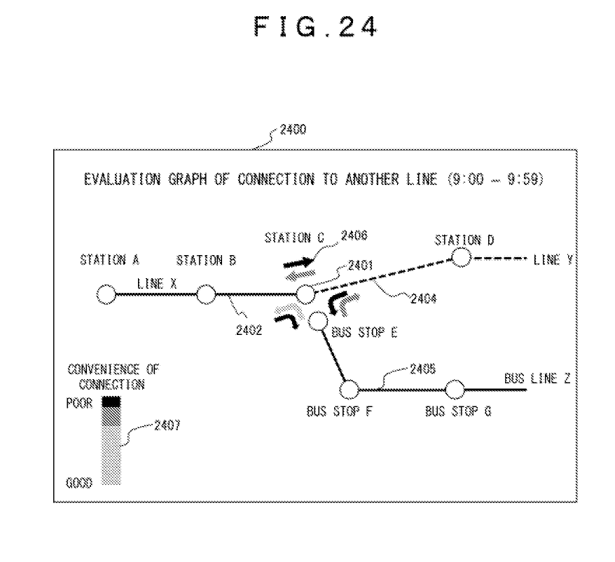

FIG. 24 shows one example of presented screen generated and distributed by the information distributing server (150) to a transportation company official (186) or users (182 and 184), and is a diagram (2400) showing an example of the result of evaluating the relative convenience of transfers between different lines.

A screen (2400) is so configured that, regarding stations and bus stops (2401) where transfers between different lines are possible on a structure including places where people board and alight, such as stations and bus stops, and lines (2402) linking them, evaluation of transfer convenience is expressed in various forms including shape, color and text. For instance, if a transfer between railway lines X (2402) and Y (2404) is possible at station C (2401) and bus line Z (2405) is also in operation, evaluation results (2406) regarding six directions, from line X to line Y, from line Y to line X, from line X to bus line Z, from bus line Z to line X, from line Y to bus line Z and from bus line Z to line Y are indicated concerning the surroundings of station C. To evaluate the relative convenience of a transfer, the length of waiting for the train or bus to which the transfer is to be made from a given line can be calculated and the total loss time, namely how many people should wait for how many hours, can be figured out. It is more desirable for this transfer evaluation to be made in finer time grain, namely at intervals of 30 minutes or one hour for instance, because this would make possible distinction between time brackets of smooth transfers and time brackets of not so smooth transfers.

Regarding the way of indicating the result of transfer evaluation, some other shape than arrows may be used, or allocation of colors using a color chart (2407) or the shape size may be contrived. Use of such a screen would allow discovery of locations of inconvenience in transfers, in terms of what part of what station, and this discovery can be utilized in planning timetables reflecting consideration for convenient transfers.

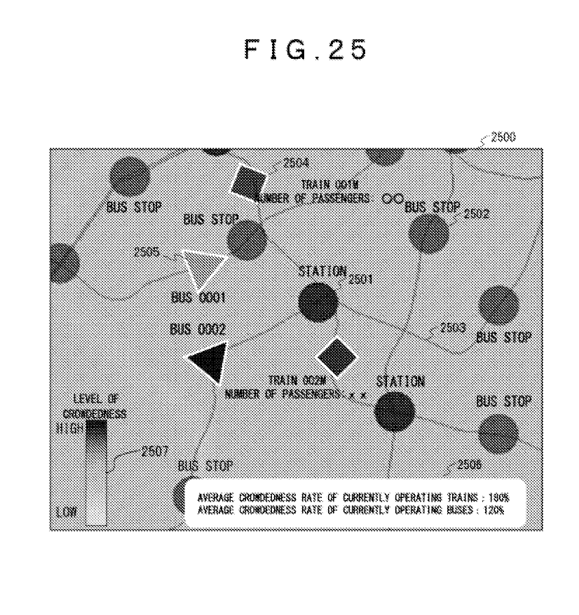

FIG. 25, showing one example of presented screen generated and distributed by the information distributing server (150) to the transportation company official (186) or the users (182 and 184), is a diagram (2500) showing an exemplar result of visualization of the operating positions and passenger numbers of buses and trains, the crowdedness rate figured out by a crowdedness rate estimation program and other factors.

The diagram (2500) is so configured that icons representing transportation means including stations (2501) and bus stops (2502) with a map image in the background, lines (2503) representing traffic lines and operation routes linking those places and icons representing trains (2504) and buses (2505) vary in a time series. The icons representing stations and bus stops may indicate additional information along the time axis by their color, shape and size; for example, the number of persons waiting for the next train or bus at a station or a bus stop or the total hours of waiting time may be indicated. By varying indications from moment to moment for every station or bus stop in search of the number of waiting persons and the waiting hours, it is possible to find out at what station or bus stop stagnation is likely to occur or crowdedness tends to arise.

It is also possible for icons representing trains and buses to represent various kinds of information by their color, shape, size or additional text indication; for instance, it is conceivable to use a color chart (2507) to set colors or use different icon shapes or sizes according to the crowdedness level, delay time length and connection time taken to make a transfer.

Movements of trains or buses can be calculated on the basis of the actual timetable data according to the present invention, and the number of persons boarding each train or bus can be known from the execution result of the number of users estimation program (139). If on this occasion the actual timetable data determining the movements of trains or buses is replaced with other newly prepared timetable data and the number of users estimation program (139) is executed, a passenger stream simulation covering all elements including trains and buses is made possible.

Further, the whole screen can be manipulated by using an input interface such as a mouse or a keyboard, for instance to be provided with functions to achieve zooming in or out with a wheel button or the like, to designate a position on the line by mouse dragging and to enlarge information on a specific station, bus stop or line by clicking the mouse. Or by figuring out the average crowdedness rate of the trains or buses displayed and giving display (2506) as an overall indicator, it is made possible to macroscopically grasp the efficiency of transportation or the comfort of passengers. The use of such a screen allows tracking of movements train by train or bus by bus, searching for chronically congested lines, trains or buses, overall viewing of what place many people are waiting and utilizing such findings for policy planning to reduce crowdedness.

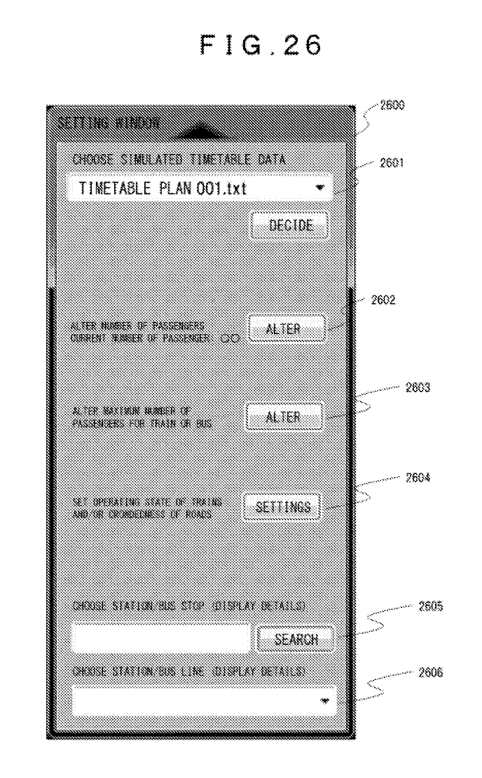

FIG. 26, showing one example of presented screen generated and distributed by the information distributing server (150) to officials of the system operator or the transportation business operator, is a screen (2600) for setting various parameter variables of the aforementioned passenger stream simulation. The screen (2600) includes, first, a function (2601) to choose timetable data, which constitutes information on train and bus operation, an altering function (2602) for the number of passengers, a function (2603) to alter the maximum passenger capacities of trains and buses, and a function (2604) to set the train operation state and the congested state of roads. It may also include selective functions (2605 and 2606) for efficient choice of an object desired for viewing on a simulation visualization result screen (2500) and the like. The object desired for viewing in this context means a certain station or bus stop, or a railway line or a bus line, suggesting a configuration in which the viewpoint in a display automatically varies in response to inputted information.

Since the user is enabled by the function (2601) to choose certain timetable data, which constitute information on train and bus operation, to compare results of calculation based on the timetable data, it is made possible for him or her to formulate a seemingly optimal timetable from the viewpoints of the number of passengers and transit time between stations, the convenience for passengers and the efficiency of transportation.

In the case of simulating here the load factor and crowdedness rate of each train or bus on the basis of given timetable data, data on the needs of passengers is required as a premise. The data on the needs of passengers means data statistically obtained regarding the number of people travelling on a given day in a given time bracket from a given departure point to a given destination. The altering function (2602) for the number of passengers is to increase or decrease the volume of this passenger demand data, and this function can make adjustment between supposing a scene in which the overall number of transportation users is large and a scene in which the number is small.

The function (2603) to alter the maximum passenger capacities of trains and buses is used for the purpose of altering reference values in calculating the crowdedness rate of each train or bus. For instance, it can predict how crowdedness and the length of waiting time vary when a train or bus differing in transportation capacity is deployed. It is desirable for this function to permit setting for individual train or bus in combination with timetable data desired to be simulated.

The function (2604) to set the train operation state and the congested state of roads is used for the purpose of giving external variation factors to the timetable data desired to be simulated; for instance obstacles to transportation or delay are set for railways, or road congestion is set for bus lines to add a probability element for delays in operation, leading to a simulation result closer to the reality.

Information for generating screens of FIG. 19 through FIG. 26 is accumulated in the memory unit (141) of the calculation server (130), and called up when the system operator (172), the officials of transportation business operators (186) or the users (182 and 184) access a prescribed Web page or when an application working on the client PC is actuated and, in accordance with conditions designated by choice items from a pull-down menu or the like, resulting in acquisition of required information. The information distributing server (150) edits the acquired information and distributes the information.

Whereas embodiments of the present invention have been hitherto described, the present invention is not limited to these embodiments and permits implementation in various modified ways, and persons skilled in the art would understand that these embodiments can be appropriately combined with one another.

### LIST OF REFERENCE SIGNS

100 . . . User; 101 . . . IC card; 102 . . . Ticket gate; 103 . . . Bus; 104 . . . Mobile terminals; 105 . . . User; 106 . . . Taxi; 107 . . . Network; 108 . . . Departure/arrival timetable estimating system; 110 . . . Data server; 111 . . . Memory unit; 112 . . . Contactless type IC card data; 113 . . . Master data; 114 . . . Station (bus stop) master; 115 . . . Route master; 116 . . . Transit log data; 117 . . . Single line user estimation data; 118 . . . Departure/arrival timetable data; 119 . . . Number of users data; 130 . . . Calculation server; 131 . . . Network interface; 132 . . . memory; 133 . . . CPU; 134 . . . Transit log generation program; 135 . . . Single line user estimation program; 136 . . . Arrival time estimation program; 137 . . . Departure time estimation program; 138 . . . Crowdedness rate estimation program; 139 . . . Number of users estimation program; 141, 142 . . . Memory unit; 150 . . . Information distributing server; 151 . . . Network interface; 152 . . . Memory unit; 153 . . . CPU; 154 . . . Memory; 155 . . . Simulation program; 156 . . . Display screen generation program; 157 . . . Query acquisition program; 158 . . .

Network interface; 170 . . . Network; 171 . . . Operation terminal; 172 . . . System user; 173 . . . Network; 181 . . . User; 182 . . . Mobile terminal; 183 . . . Operation terminal; 184 . . . User; 185 . . . Operation terminal; 186 . . . business operator; 200 . . . Log ID; 201 . . . User ID; 202 . . . Station (bus stop) ID; 203 . . . Time of use; 204 . . . Type of use; 300 . . . Log ID; 301 . . . User ID; 302 . . . Boarding day and time; 303 . . . Alighting day and time; 304 . . . Boarding position ID; 305 . . . Alighting position ID; 400 . . . Line ID; 401 . . . Line name; 402 . . . Line type; 403, 404, 405 . . . Station to stop; 500 . . . Log ID; 501 . . . User ID; 502 . . . Boarding day and time; 503 . . . Alighting day and time; 504 . . . Boarding position ID; 505 . . . Alighting position ID; 600 . . . Departure/arrival timetable ID; 602 . . . Station to stop (bus stop); 603 . . . Arrival time; 604 . . . Departure time; 700 to 712 . . . Processing steps; 800 to 806 . . . Processing steps; 900 . . . Conceptual diagram of distribution of number of alighting persons; 901 . . . Vertical axis (number of alighting persons); 902 to 905 . . . Histogram of number of alighting persons; 906 . . . Noted station or bus stop; 907 . . . Horizontal axis (time); 908 . . . Time of appearance of consecutive histograms; 1000 to 1013 . . . Processing steps; 1100 to 1110 . . . Processing steps; 1200 to 1208 . . . Processing steps; 1300 to 1304 . . . Processing steps; 1400 to 1403 . . . Processing steps; 1500 . . . Exemplar display of timetable expressly showing crowdedness rate; 1501 . . . Vertical axis (station to stop or bus stop); 1502 . . . Horizontal axis (time); 1503 . . . Station to stop or bus stop name; 1504 . . . Line illustrating operating state based on departure/arrival timetable; 1505 . . . Line showing operating state based on planned timetable; 1506 . . . Diagram showing color varying with crowdedness rate; 1507 . . . Diagram showing lines of departure/arrival timetable; 1508 . . . Diagram showing lines of planned timetable; 1600 . . . Exemplar display of timetable expressly showing crowdedness rates of different transportation facilities; 1601 . . . Horizontal axis (time); 1602 . . . Vertical axis (station to stop or bus stop); 1603 . . . Name of station to stop or bus stop; 1604 . . . Lines for clear expression of transfer parts between different transportation facilities; 1605 . . . Lines illustrating operating state based on departure/arrival timetable; 1606 . . . Diagram showing color varying with crowdedness rate; 1700 . . . Exemplar line map expressly showing crowdedness rate; 1701 . . . Name of station to stop; 1702 . . . Point representing station to stop; 1703 . . . Point representing transportation line; 1704 . . . Line representing high crowdedness rate transportation line; 1705 . . . Line representing low crowdedness rate transportation line; 1706 . . . Diagram showing color varying with crowdedness rate; 1707 . . . Point of time; 1800 . . . Exemplar line map expressly showing deviation from timetable; 1801 . . . Name of station to stop; 1802 . . . Point representing station to stop; 1803 . . . Line representing transportation line; 1804 . . . Line representing transportation line with many deviations from timetable; 1805 . . . Line representing transportation line with few deviations from timetable; 1806 . . . Diagram showing color varying with crowdedness rate; 1807 . . . Point of time; 1900 . . . Exemplar display of route search results in ascending order of predictable crowdedness rate; 1901 . . . Departure point; 1902 . . . Destination point; 1903 . . . Departure point input column; 1904 . . . Destination input column; 1905 . . . Departure time and arrival time of route 1; 1906 . . . Display column for fare, number of transfers and predictable crowdedness rate for route 1; 1907 . . . Departure time and arrival time of route 2; 1908 . . . Display column for fare, number of transfers and predictable crowdedness rate for route 2; 1909 . . . Departure time and arrival time of route 3; 1910 . . . Display column for fare, number of transfers and predictable crowdedness rate for route 3; 1911 to 1913 . . . Display column for route ID numbers of different search results; 2000 . . . Exemplar display of detailed screen when route 1 is chosen; 2001 . . . Departure point; 2002 . . . Destination point; 2003 . . . Departure point input column; 2004 . . . Destination input column; 2005 . . . Departure time and arrival time of route 1; 2006 . . . Display column for fare, number of transfers and predictable crowdedness rate for route 1; 2007 . . . Detailed display of station to stop, time, fare and predictable crowdedness rate for route 1; 2100 . . . Exemplar display of route search results in ascending order of predictable delay time length; 2101 . . . Departure point; 2102 . . . Destination point; 2103 . . . Departure point input column; 2104 . . . Destination input column; 2105 . . . Departure time and arrival time of route 1; 2106 . . . Display column for fare, number of transfers and predictable delay time length for route 1; 2107 . . . Departure time and arrival time of route 2; 2108 . . . Display column for fare, number of transfers and predictable delay time length for route 2; 2109 . . . Departure time and arrival time of route 3; 2110 . . . Display column for fare, number of transfers and predictable delay time length for route 3; 2111 to 2113 . . . Display column for route ID numbers of different search results; 2200 . . . Exemplar display of detailed screen when route 1 is chosen; 2201 . . . Departure point; 2202 . . . Destination point; 2203 . . . Departure point input column; 2204 . . . Destination input column; 2205 . . . Departure time and arrival time of route 1; 2206 . . . Summarized display of fare, number of transfers and predictable delay time length for route 1; 2207 . . . Detailed display of station to stop, time, fare and predictable delay time length for route 1; 2300 . . . Display screen for evaluation results of transfers between different transportation facilities; 2301 . . . Display column for transportation means from departure point to arrival point; 2302 . . . Arrival time; 2303 . . . Departure time; 2304 . . . Display column for evaluation; 2305 . . . From departure point to arrival point; Display column for transportation means used; 2306 . . . Arrival time; 2307 . . . Departure time; 2308 . . . Display column for evaluation; 2400 . . . Screen for evaluation of transfer; 2401 . . . Transfer-possible place; 2402 to 2405 . . . Line; 2406 . . . Transfer evaluation icon; 2407 . . . Color chart; 2500 . . . Screen for fluid state visualization result; 2501 . . . Station; 2502 . . . Bus stop; 2503 . . . Line; 2504 . . . Train; 2505 . . . Bus; 2506 . . . Overall indicator; 2507 . . . Color chart; 2600 . . . Condition setting screen; 2601. . . Screen for timetable data choice; 2602 . . . Passenger number altering function; 2603 . . . Altering function for train/bus transportation capacities; 2604 . . . Setting function for train operation state and road congestion state; 2605 to 2606 . . . Display position choosing function

1. A transportation analysis system using a database including a transit log in which a user ID, a boarding day and time, an alighting day and time, a boarding position and an alighting position are associated with one another and a line master in which a line ID and station-to-stop information are associated with each other, the system comprising:
a single line estimating unit in which the transit log and the line master are extracted from the database, the presence or absence of a line ID including the boarding position and the alighting position associated with the transit log is confirmed on the basis of the line master and, if the presence is confirmed, single line estimating information associating the confirmed line ID and the transit log with each other is generated and stored into the database; and
a departure/arrival timetable estimating unit that extracts the line master and the single line estimating information from the database, calculates, on the basis of the line master, the distribution of the number of alighting persons in the alighting position contained in the single line estimating information, calculates an arrival day and time and a departure day and time on the basis of the calculated distribution of the number of alighting persons, generates a departure/arrival timetable ID associated with each of the alighting position, the calculated arrival day and time and departure day and time and the line ID, and stores the ID into the database.

2. The transportation analysis system according to claim 1, further having:
a passenger number calculating unit that extracts, from the database, the transit log and the departure/arrival timetable ID, identifies a boarded train by figuring out a transit-permitting route on the basis of the departure/arrival timetable ID from the combination of the boarding position, the alighting position, the boarding day and time, the alighting day and time contained in the transit log, calculates the number of passengers on the boarded train, and stores the number into the database.

3. The transportation analysis system according to claim 2,
wherein the database further has passenger capacity information on boarded trains on each line, and
a crowdedness rate calculating unit that, using the number of passengers calculated by the passenger number calculating unit and the passenger capacity information, calculates the crowdedness rate of the boarded train is further provided.

4. The transportation analysis system according to claim 3,
wherein the database further stores weather information associated with day and time information, and
a predictable crowdedness rate calculating unit that, using the crowdedness rate calculated by the crowdedness rate calculating unit and weather information stored into the database, figures out a crowdedness rate pattern and calculates a predictable crowdedness rate on the basis of the crowdedness rate pattern is further provided.

5. The transportation analysis system according to claim 4, further having:
a display unit that extracts, from the database, the departure/arrival timetable ID and the crowdedness rate or the predictable crowdedness rate in individual station-to-stop information of the line master and displays the ID and the rate on a screen.

6. The transportation analysis system according to claim 5,
wherein the database contains a planned timetable, and
the display unit further displays the planned timetable.

7. The transportation analysis system according to claim 6, further comprising:
a deviation-from-timetable calculating unit that calculates deviations from timetables on the basis of the difference between the planned timetable and the departure/arrival timetable ID.

8. The transportation analysis system according to claim 4, further comprising:
an input unit that accepts inputs of a departure point and a destination, and
a route searching unit that, on the basis of the departure point and the destination of which the inputs were accepted, searches the line master to extract station-to-stop information matching each, calculates a predictable crowdedness rate with respect to the station-to-stop information, and makes the rate a predictable route crowdedness rate,
wherein the display unit displays the predictable route crowdedness rate on the screen.

9. The transportation analysis system according to claim 8,
wherein the line master in the database contains fare information associated with the station-to-stop information;
the display unit displays the extracted matching station-to-stop information on the screen; and
the input unit accepts an input to choose the displayed matching station-to-stop information, the system further comprising:
a detail display unit that, on the basis of the station-to-stop information of which the input was accepted, extracts related fare information from the database and displays the information on the screen.

10. The transportation analysis system according to claim 8, further comprising:
a transfer evaluating unit that calculates a transfer-permitting time length from the departure/arrival timetable ID and evaluates a transfer evaluation level on the basis of the transfer-permitting time length and the number of passengers.

11. The transportation analysis system according to claim 10,
wherein the transfer evaluating unit further figures out the direction of transfer from the departure/arrival timetable ID, and
the display unit displays the direction of transfer and the transfer evaluation level on the screen.

12. The transportation analysis system according to claim 8,
wherein the database further stores map information; and
the display unit displays the map information, the predictable crowdedness rate, the station-to-stop information and the number of passengers on the screen.

13. The transportation analysis system according to claim 3, further comprising:
an input unit that accepts inputs of any or all of the line master, the number of passengers and the passenger capacity and stores it or them into the database.

14. The transportation analysis system according to claim 3, further comprising:
an input unit that accepts inputs of operating state information and stores the information into the database,
wherein the departure/arrival timetable estimating unit, using the operating state information, generates the number of passengers or travel time associated with the line master or individual station-to-stop information.
